(19) United States
(12) Patent Application Publication
(10) Pub. No.: US 2022/0376309 A1
(43) Pub. Date: Nov. 24, 2022

(54) DEVICE AND METHOD FOR AN OIL-COOLED BATTERY MANAGEMENT SYSTEM OF A HIGH VOLTAGE BATTERY

(71) Applicant: Dr. Ing. h.c. F. Porsche Aktiengesellschaft, Stuttgart (DE)

(72) Inventors: Philipp Kellner, Renningen (DE); Christopher Volkmer, Niefern-Öschelbronn (DE)

(73) Assignee: Dr. Ing. h.c. F. Porsche Aktiengesellschaft, Stuttgart (DE)

(21) Appl. No.: 17/749,253

(22) Filed: May 20, 2022

(30) Foreign Application Priority Data
May 21, 2021 (DE) 10 2021 113 223.1

(51) Int. Cl. H01M 10/42; H01M 10/613; H01M 10/6567

(52) U.S. Cl. CPC H01M 10/425; H01M 10/613; H01M 10/6567; H01M 10/4207; H01M 2010/4271

(57) ABSTRACT

A device and method for cooling a battery management system (BMS). The BMS includes electronic components arranged inside a BMS housing. The BMS housing has at least one BMS coolant inflow connection for a coolant inflow and at least one BMS coolant outflow connection for a coolant outflow. A dielectric coolant flows around at least part of at least one electronic component inside the BMS housing. A high-voltage battery has the BMS and a plurality of battery modules that are strung together. Each battery module includes, on at least one module housing side, at least one coolant inflow connection for a coolant inflow. The high-voltage battery also includes a hollow section connected to the BMS and to the string of battery modules in a media-tight manner.

### CROSS-REFERENCE TO RELATED APPLICATION

This application claims priority to German Patent Application No. 10 2021 113 223.1, filed May 21, 2021, the content of such application being incorporated by reference herein in its entirety.

### FIELD OF THE INVENTION

The present invention relates to a device for cooling a battery management system of a high-voltage battery, in which a dielectric medium is flushed through the battery management system. A method that provides the cooling of the battery management system with the aid of the device is also described.

### BACKGROUND OF THE INVENTION

During charging or discharging processes on battery cells in a traction battery of an electric vehicle, heat is produced, which can damage the battery. In order to ensure a long service life for the battery cells, the battery must therefore be cooled. According to the prior art, such cooling can be performed by way of a separate cooling system with a coolant. Cooling lines of the cooling system can be thermally connected to the battery cells, for example by means of a heat-conducting paste.

In addition to the production of heat in the battery cells, heat is also produced in a battery management system during operation, that is to say, for example, when the electric vehicle is driven (discharging process) or when the battery is charged. In particular at high system powers, it is necessary to dissipate the waste heat by means of active cooling in order to prevent damage or malfunctions in the battery management system. However, in many applications, either the battery management system is not actively cooled or the battery management system is only in surface contact with cooling plates through which coolant flows.

In CN 108461681 A, which is incorporated by reference herein, the battery cells and the battery management system are arranged on a cooling plate. A cooling liquid flows through the cooling plate.

US 2014/0178721 A1, which is incorporated by reference herein proposes integrating the battery cell unit and the battery management unit in a joint structure. A coolant circulates within the structure.

DE 10 2019 209 155 A1, which is incorporated by reference herein relates to an energy storage arrangement having a temperature-control device for cooling or heating the at least one energy storage element, which comprises two electrical cell outgoing conductors. The temperature-control device can spray at least the cell outgoing conductors with a dielectric temperature-control liquid.

### SUMMARY OF THE INVENTION

Against this background, described herein is a device for cooling a battery management system that takes into account the increased demands in a high-voltage battery with respect to a dissipation of waste heat that is required in the battery management system. The intention in this case is for as little installation space and weight as possible to be required. In addition, the intention is to provide a corresponding method for cooling the battery management system with the aid of the device.

To solve the problem mentioned above, a device for cooling a battery management system is proposed, wherein the battery management system, referred to as BMS for short by a person skilled in the art, comprises a plurality of electronic components arranged inside a BMS housing. The BMS housing comprises at least one BMS coolant inflow connection for a coolant inflow and at least one BMS coolant outflow connection for a coolant outflow. A dielectric coolant flows around at least part of at least one electronic component inside the BMS housing.

The dielectric coolant is formed, for example, by a purified oil, which does not have any electrically conductive impurities. The dielectric coolant's flowing directly around at least parts of electronic components inside the BMS in accordance with the invention advantageously has a high cooling power or a high cooling performance, for example one which is increased compared to the connection of the BMS to a cooling plate by means of a heat-conducting paste that is known from the prior art. Waste heat from the BMS arising during operation is therefore dissipated directly to the respective electronic components in which heat is produced, and does not disadvantageously have to get to a cooling plate through thermal diffusion, which can also adversely affect other components of the BMS.

In one configuration of the device according to aspects of the invention, at least one electronic component is selected from the following list: contactor, printed circuit board with integrated circuits, power connection, electrical connection to at least one battery module. An electrical connection to the at least one battery module is formed, for example, by way of a pole connection and/or a busbar.

In a further configuration of the device according to aspects of the invention, the battery management system is connected to a cooling circuit of an electrical traction system. The electrical traction system is a drive of an electric vehicle or an at least partly electrically driven hybrid vehicle, for example.

In a preferred configuration of the device according to aspects of the invention, the battery management system comprises at least two coolant connections for the dielectric coolant. As a result, the coolant is advantageously supplied to the battery management system at at least two positions that are physically separate from one another, which leads to a more effective flow through the battery management system and associated greater heat dissipation in the battery management system. In a particularly preferred configuration of the device according to aspects of the invention, the at least two coolant connections are arranged on opposite sides of the BMS housing, and specifically at a respective location of the BMS housing that is located furthest away from the BMS coolant outflow connection, leading to a particularly advantageous flow through the BMS housing.

A further aspect of the invention relates to a high-voltage battery having a battery management system described above. The high-voltage battery comprises a plurality of battery modules that are strung together, wherein each battery module comprises a module housing, two pole connections, at least one energy storage cell arranged in the module housing, and a direct cell flow system having a dielectric coolant. Each battery module comprises, on at least one module housing side, at least one coolant inflow connection for a coolant inflow and, on a module housing cover, on which the two pole connections are also located, a coolant outflow opening for a coolant outflow. A sequence of the coolant inflows with a first coolant inflow and a last coolant inflow is stipulated by the stringing together of the battery modules, wherein the battery module with the last coolant inflow forms an end side as one end of the string. The battery management system is arranged on said end side. The high-voltage battery is connected to a cooling system.

The cooling system comprises, for example, a cooler, through which a cooling air flows, and a coolant pump. The cooling air is formed, for example, by airflow from a traveling electric vehicle.

The dielectric coolant's flowing directly around the at least one energy storage cell arranged in the module housing in accordance with the invention advantageously has a high cooling power, in particular a higher cooling power in comparison with a dissipation of heat merely by way of a cooling plate connected via a surface contact. The high cooling power facilitated by the device according to aspects of the invention both inside the battery management system and inside each module housing advantageously ensures rapid charging of the high-voltage battery, the rapid charging generally leading to a greater amount of waste heat compared to a comparatively slow charging process, for example caused by a low voltage level.

In a first configuration of the high-voltage battery according to aspects of the invention, the at least one BMS coolant inflow connection is configured to form a coolant interface directly connected to a coolant inflow from the cooling system. Dielectric coolant flows from said coolant interface to the respective coolant inflow connections of the battery modules.

In a second configuration of the high-voltage battery according to aspects of the invention, the at least one BMS coolant outflow connection is configured to form a return flow interface directly connected to a coolant return flow into the cooling system. Dielectric coolant flows to said return flow interface from the respective coolant outflow connections of the battery modules.

The battery management system is advantageously integrated in the coolant circuit of the high-voltage battery by way of the first configuration of the high-voltage battery according to aspects of the invention and/or the second configuration of the high-voltage battery according to aspects of the invention. As a result, additional cooling devices, such as a separate cooling system, for example, for the battery management system are advantageously dispensed with.

In another configuration of the high-voltage battery according to aspects of the invention, the high-voltage battery additionally comprises a hollow section connected to the battery management system and to the string of battery modules in a media-tight manner. The section is designed to surround the at least one BMS coolant inflow connection and all of the coolant outflow openings and pole connections, of the battery modules, extending therein. The section is configured to receive coolant flowing out of the coolant outlet openings along the battery modules that are strung together and to conduct same to the at least one BMS coolant inflow connection of the battery management system located on the end side.

Due to the inventive arrangement of the section, the same coolant flows through the battery management system as through the battery modules that are strung together, which advantageously eliminates additional cooling devices for the battery management system and has a cost-reducing and installation-space-reducing effect.

Likewise, the third configuration of the high-voltage battery according to aspects of the invention results in the battery management system being integrated in the coolant circuit of the high-voltage battery with only a lower priority, so that, initially, colder coolant coming directly from the cooler and, for physical reasons, having a higher capacity for heat absorption advantageously flows through the string of battery modules, as a result of which the heat dissipation from the energy storage cells is more efficient and is not encumbered by the battery management system. Only after this does coolant that has already been heated by the waste heat from the battery modules flow through the battery management system. This is due to the fact that, for example, comparatively less waste heat arises in the battery management system than is the case when looking at all of the battery modules together.

In yet another configuration of the high-voltage battery according to aspects of the invention, the battery management system is connected to the battery modules via busbars running inside the section. As a result, coolant flows around the busbars.

In yet another configuration of the high-voltage battery according to aspects of the invention still, all of the coolant inflow connections of the battery modules are connected to a coolant distributor having a single coolant inlet. The at least one BMS coolant outflow connection is formed as a coolant outlet. As a result, a closed cooling system is formed.

In yet another configuration of the high-voltage battery according to aspects of the invention again, the BMS housing, all of the module housings and the section are formed by an overall housing.

A method for arranging a cooling of a battery management system is also described, in which the battery management system (BMS) comprises a plurality of electronic components arranged inside a BMS housing. At least one BMS coolant inflow connection for a coolant inflow and at least one BMS coolant outflow connection for a coolant outflow are formed on the BMS housing. A dielectric coolant flows around at least part of at least one electronic component inside the BMS housing, wherein the dielectric coolant is supplied to the battery management system by way of the at least one BMS coolant inflow connection and is discharged again by way of the at least one BMS coolant outflow connection.

In one embodiment of the method according to aspects of the invention, the battery management system is arranged in a high-voltage battery. The high-voltage battery comprises a plurality of battery modules that are strung together, wherein each battery module comprises a module housing, two pole connections, at least one energy storage cell arranged in the module housing, and a direct cell flow system having a dielectric coolant. Each battery module comprises, on at least one module housing side, at least one coolant inflow connection for a coolant inflow and, on a module housing cover, on which the two pole connections are also located, a coolant outflow opening for a coolant outflow. A sequence of the coolant inflows with a first coolant inflow and a last coolant inflow is stipulated by the stringing together of the battery modules, wherein the battery module with the last coolant inflow forms an end side as one end of the string.

The battery management system is arranged on said end side. The battery management system is connected to a cooling system connected to the high-voltage battery.

In a further embodiment of the method according to aspects of the invention, the high-voltage battery additionally comprises a hollow section connected to the battery management system and to the string of battery modules in a media-tight manner. The at least one BMS coolant inflow connection and all of the coolant outflow openings and pole connections, of the battery modules, extending therein are surrounded by the section. The section is used to receive coolant flowing out of the coolant outlet openings along the battery modules that are strung together and to conduct same to the at least one BMS coolant inflow connection of the battery management system located on the end side.

### BRIEF DESCRIPTION OF THE DRAWINGS

Further advantages and configurations of the invention emerge from the description and from the appended drawing.

It is understood that the features mentioned above and the features yet to be discussed below may be used not only in the respectively specified combination but also in other combinations or individually without departing from the scope of the present invention.

The figures are described cohesively and comprehensively and identical components are assigned the same reference symbols.

FIG. 1 schematically shows a flow profile in a top view of one configuration of the high-voltage battery according to aspects of the invention.

FIG. 2 schematically shows a lateral sectional illustration of the configuration of the high-voltage battery according to aspects of the invention.

### DETAILED DESCRIPTION OF THE INVENTION

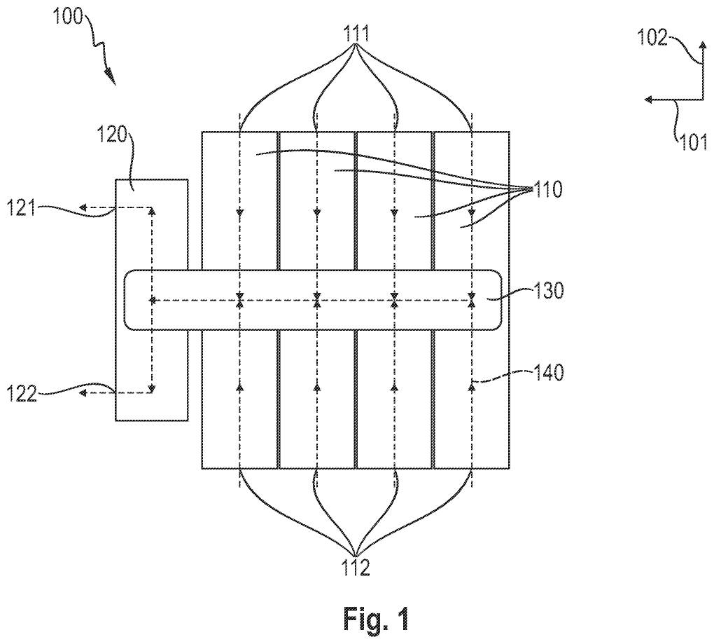

FIG. 1 schematically shows a flow profile in a top view 100 of one configuration of the high-voltage battery according to aspects of the invention. The high-voltage battery has a plurality of battery modules 110 that are strung together in the positive direction of an x axis 101, said battery modules each individually having a right-hand coolant inflow connection 111 (on the positive side of a y axis 102) and a left-hand coolant inflow connection 112 (on the negative side of the y axis 102). A battery management system (BMS) 120 is arranged on a battery module 110, which forms one end of the string and comprises the topmost or last coolant inflows 111, 112 in the direction of the x axis 101. The battery management system 120 has a right-hand BMS coolant outflow connection 121 and a left-hand BMS coolant outflow connection 122 in relation to the positive side and the negative side of the y axis 102. Above the string of battery modules 110 and the battery management system 120, there is a section 130, which surrounds both upper coolant outflow openings of the battery modules 110 and a BMS coolant inflow connection of the battery management system 120 in a media-tight manner. Coolant flows through the coolant inflow connections 111, 112 in a coolant flow direction 140 through the respective battery modules, which each surround at least one energy storage cell, into the section 130 and from there through the battery management system 120 to the BMS coolant outflow connections 121, 122.

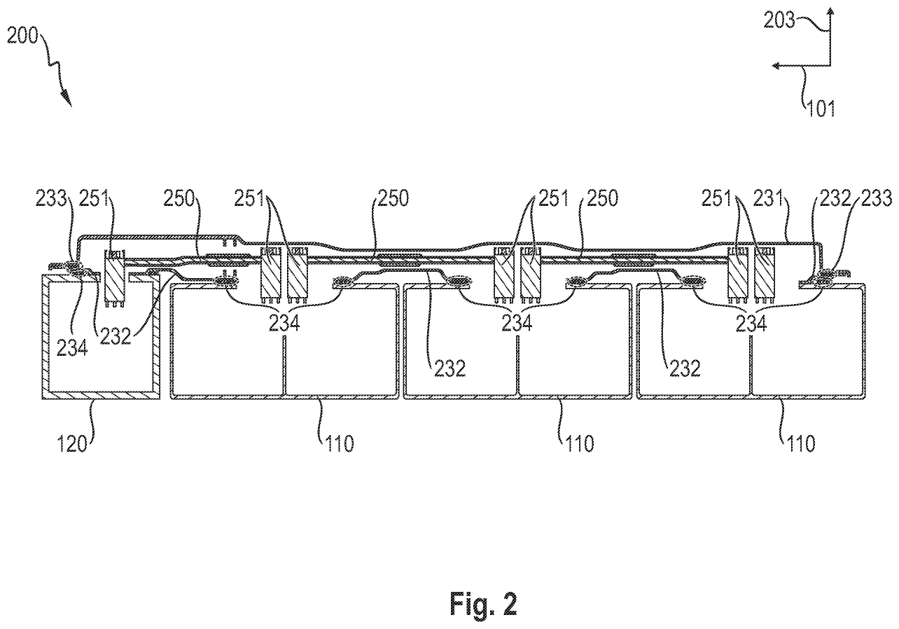

FIG. 2 schematically shows a lateral sectional illustration 200 of the configuration of the high-voltage battery according to aspects of the invention. In the positive direction of a z axis 203, a lower part of the section 232 is arranged on the battery modules 110 and the battery management system 120, above the battery modules 110 and the battery management system 120, using intermediate seals 234. An upper part of the section 231 is then connected to the lower part of the section 232 in a media-tight manner, again using seals 233 as a continuation. The upper part of the section 231 and the lower part of the section 232 form the section 130 from FIG. 1. In a cavity formed by the upper part of the section 231 and the lower part of the section 232, coolant flows around pole connections 251 to the battery modules 110 and to the battery management system 120 and around busbars 250 that electrically connect these to one another.

### LIST OF REFERENCE DESIGNATIONS

100 Top view of flow profile
101 x axis
102 y axis
110 Battery module
111 Right-hand coolant inflow connection
112 Left-hand coolant inflow connection
120 Battery management system
121 Right-hand BMS coolant outflow connection
122 Left-hand BMS coolant outflow connection
130 Section
140 Direction of flow of the coolant
200 Lateral sectional illustration of the cooling arrangement
203 z axis
231 Upper part of the section
232 Lower part of the section
233 Seal between the upper part of the section and the lower part of the section
234 Seal between the lower part of the section and positioned parts
250 Busbar
251 Pole connections

What is claimed is:

1. A device for cooling a battery management system (BMS), said device comprising:
a BMS housing comprising at least one BMS coolant inflow connection for a coolant inflow and at least one BMS coolant outflow connection for a coolant outflow;
a plurality of electronic components arranged inside the BMS housing; and
a dielectric coolant passageway through which dielectric coolant flows around at least part of at least one electronic component inside of the BMS housing.

2. The device as claimed in claim 1, wherein at least one electronic component of the plurality of electronic components is selected from the group consisting of: contactor, printed circuit board with integrated circuits, power connection, and an electrical connection to at least one battery module.

3. The device as claimed in claim 1, wherein the BMS is connected to a cooling circuit of an electrical traction system.

4. A high-voltage battery having the battery management system as claimed in claim 1, wherein the high-voltage battery comprises a plurality of battery modules that are strung together, wherein each battery module comprises a module housing, two pole connections, at least one energy storage cell arranged in the module housing, and a direct cell flow system having a dielectric coolant, wherein each battery module comprises, on at least one module housing side, at least one coolant inflow connection for a coolant inflow and, on a module housing cover, on which the two pole connections are also located, a coolant outflow opening for a coolant outflow, in which a sequence of the coolant inflows with a first coolant inflow and a last coolant inflow is stipulated by stringing together of the battery modules, wherein the battery module with the last coolant inflow forms an end side as one end of the string, wherein the battery management system is arranged on said end side, and wherein the high-voltage battery is connected to a cooling system.

5. The high-voltage battery as claimed in claim 4, wherein the at least one BMS coolant inflow connection is configured to form a coolant interface connected directly to a coolant inflow from the cooling system, wherein dielectric coolant flows from said coolant interface to the respective coolant inflow connections of the battery modules.

6. The high-voltage battery as claimed in claim 4, wherein the at least one BMS coolant outflow connection is configured to form a return flow interface connected directly to a coolant return flow into the cooling system, wherein dielectric coolant flows to said return flow interface from the respective coolant outflow connections of the battery modules.

7. The high-voltage battery as claimed in claim 4, wherein the high-voltage battery additionally comprises a hollow section connected to the battery management system and to the string of battery modules in a media-tight manner, wherein the section is configured to surround the at least one BMS coolant inflow connection and all of the coolant outflow openings and pole connections, of the battery modules, extending therein, wherein the section is configured to receive coolant flowing out of the coolant outlet openings along the battery modules that are strung together and to conduct the coolant to the at least one BMS coolant inflow connection of the battery management system located on the end side.

8. The high-voltage battery as claimed in claim 7, wherein the battery management system is connected to the battery modules via busbars running inside the hollow section, as a result of which coolant flows around the busbars.

9. The high-voltage battery as claimed in claim 7, wherein all of the coolant inflow connections of the battery modules are connected to a coolant distributor having a single coolant inlet, and in which the at least one BMS coolant outflow connection is formed as a coolant outlet, as a result of which a closed cooling system is formed.

10. The high-voltage battery as claimed in claim 7, wherein the BMS housing, all of the module housings and the hollow section are formed by an overall housing.

11. A method for arranging a cooling of a battery management system (BMS), said method comprising:
arranging a plurality of electronic components of the BMS inside of a BMS housing, wherein at least one BMS coolant inflow connection for a coolant inflow and at least one BMS coolant outflow connection for a coolant outflow are formed on the BMS housing, and wherein a dielectric coolant passageway is formed on the BMS housing through which dielectric coolant flows around at least part of at least one electronic component of the plurality of electronic components inside of the BMS housing.

12. The method as claimed in claim 11, further comprising arranging the battery management system in a high-voltage battery, wherein the high-voltage battery comprises a plurality of battery modules that are strung together, wherein each battery module comprises a module housing, two pole connections, at least one energy storage cell arranged in the module housing, and a direct cell flow system having a dielectric coolant, wherein each battery module comprises, on at least one module housing side, at least one coolant inflow connection for a coolant inflow and, on a module housing cover, on which the two pole connections are also located, a coolant outflow opening for a coolant outflow, in which a sequence of the coolant inflows with a first coolant inflow and a last coolant inflow is stipulated by the stringing together of the battery modules, wherein the battery module with the last coolant inflow forms an end side as one end of the string, wherein the battery management system is arranged on said end side, and wherein the battery management system is connected to a cooling system that is connected to the high-voltage battery.

13. The method as claimed in claim 12, wherein the high-voltage battery additionally comprises a hollow section connected to the battery management system and to the string of battery modules in a media-tight manner, wherein the at least one BMS coolant inflow connection and all of the coolant outflow openings and pole connections, of the battery modules, extending therein are surrounded by the section, wherein the section is used to receive coolant flowing out of the coolant outlet openings along the battery modules that are strung together and to conduct the coolant to the at least one BMS coolant inflow connection of the battery management system located on the end side.
